(19) United States
(12) Patent Application Publication
(10) Pub. No.: US 2016/0092022 A1
(43) Pub. Date: Mar. 31, 2016

(54) METHOD FOR REDUCING GHOST TOUCH AND ELECTRONIC DEVICE THEREOF

(71) Applicant: Samsung Electronics Co., Ltd., Gyeonggi-do (KR)

(72) Inventors: Sang-Hyun LEE, Gyeonggi-do (KR); Jun-Ik LEE, Gyeonggi-do (KR); Woo-Kwang LEE, Gyeonggi-do (KR)

(21) Appl. No.: 14/861,156

(22) Filed: Sep. 22, 2015

(30) Foreign Application Priority Data
Sep. 26, 2014 (KR) 10-2014-0129248

(51) Int. Cl. G06F 3/041; G06F 3/044

(52) U.S. Cl. CPC G06F 3/0416; G06F 3/044; G06F 2203/04104

(57) ABSTRACT

Disclosed are an apparatus and a method for reducing a ghost touch in an electronic device. According to various embodiments, the electronic device includes a touch screen, and at least one processor implementing the method, which includes detecting touches to the touch screen, and detecting a ghost touch based on at least two of: a time interval between the touches detected through the touch screen, a distance between the touches, and a touch area of the touches.

### CLAIM OF PRIORITY

This application claims priority under 35 U.S.C. §119(a) to Korean Application Serial No. 10-2014-0129248, which was filed in the Korean Intellectual Property Office on Sep. 26, 2014, the entire content of which is hereby incorporated by reference.

### TECHNICAL FIELD

The present disclosure relates to an apparatus and a method for reducing a ghost touch in an electronic device.

### BACKGROUND

With the development of information communication and semiconductor technologies, various electronic devices have developed into multimedia devices for providing a variety of multimedia services. For example, the electronic device may provide a variety of multimedia services, such as broadcasting services, wireless Internet services, camera services, music play services, and the like.

Along with an increase in the use of multimedia services, the amount of information to be processed and displayed in the electronic device has increased. Accordingly, the use of an electronic device including a touch screen is increasingly common due to their ability to improve the utilization of space to increase the size of a display area.

### SUMMARY

When the electronic device uses the touch screen, a malfunction caused by a user's unintended ghost touch may occur. For example, an unintentional malfunction by the user may occur due to the ghost touch generated by the change in the capacitance of a touch panel by an external environmental factor (e.g., water drops), or by the influence of electromagnetic fields generated inside/outside of the touch panel.

According to various embodiments of the present disclosure, there is provided an apparatus and a method for reducing a ghost touch in an electronic device.

In accordance with an aspect of the present disclosure, an electronic device is disclosed, including touch screen configured to detect touches, and at least one processor. The at least one processor is configured to detect a ghost touch based on at least two of: a time interval between the touches to the touch screen, a distance between the touches, and a touch area of the touches.

In accordance with another aspect of the present disclosure, a method in an electronic device is disclosed, comprising: detecting touches via a touch screen of the electronic device, and detecting a ghost touch based on at least two of: a time interval between the touches detected through the touch screen, a distance between the touches, and a touch area of the touches.

### BRIEF DESCRIPTION OF THE DRAWINGS

The present disclosure will be more apparent from the following detailed description taken in conjunction with the accompanying drawings, in which:

FIG. 1 is a block diagram illustrating an electronic device according to various embodiments of the present disclosure;

FIG. 2 is a block diagram illustrating a program module according to various embodiments of the present disclosure;

FIG. 3 is a block diagram illustrating a program module for selectively driving a ghost touch detection algorithm according to various embodiments of the present disclosure;

FIG. 4 illustrates a configuration of detecting a ghost touch caused by foreign substances according to various embodiments of the present disclosure;

FIG. 5 illustrates a flowchart for detecting a ghost touch based on a touch duration time in an electronic device according to various embodiments of the present disclosure;

FIG. 6 illustrates a flowchart for detecting a ghost touch based on a touch interval, a touch distance, and a touch area in an electronic device according to various embodiments of the present disclosure;

FIG. 7 illustrates a configuration for determining a touch distance according to various embodiments of the present disclosure;

FIG. 8 illustrates a flowchart for detecting a ghost touch based on a touch interval and a touch area in an electronic device according to various embodiments of the present disclosure;

FIG. 9 illustrates a flowchart for detecting a ghost touch based on a touch interval and a touch distance in an electronic device according to various embodiments of the present disclosure;

FIG. 10 illustrates a flowchart for detecting a ghost touch based on a touch distance and a touch area in an electronic device according to various embodiments of the present disclosure;

FIG. 11 illustrates a flowchart for performing calibration for touch recognition in an electronic device according to various embodiments of the present disclosure;

FIG. 12 illustrates a flowchart for selectively performing a ghost touch detection algorithm in an electronic device according to various embodiments of the present disclosure; and

FIG. 13 illustrates a block diagram of an electronic device according to various embodiments of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the present disclosure. In addition, descriptions of well-known functions and implementations are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or program module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of: a piece of furniture or a building/structure; an electronic board; an electronic signature receiving device; a projector; or various measuring instruments (e.g., a water meter, an electricity meter, a gas meter, or a wave meter).

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

Hereinafter, according to the present disclosure, a technology for reducing a ghost touch in an electronic device will be described.

According to various embodiments of the present disclosure, a touch (e.g., a touch input) may include a ‘touch-down’ in which a touch input means (e.g., a finger or a touch pen) touches a touch screen. For example, when using a capacitive touch scheme, an electronic device may detect a touch (e.g., a touch event) corresponding to the change in a capacitance, equal to or greater than a reference capacitance due to the touch of the touch input means on a touch screen. A touch-release (e.g., touch off) may include a ‘touch-up’ in which the touch of the touch input means on the touch screen is released.

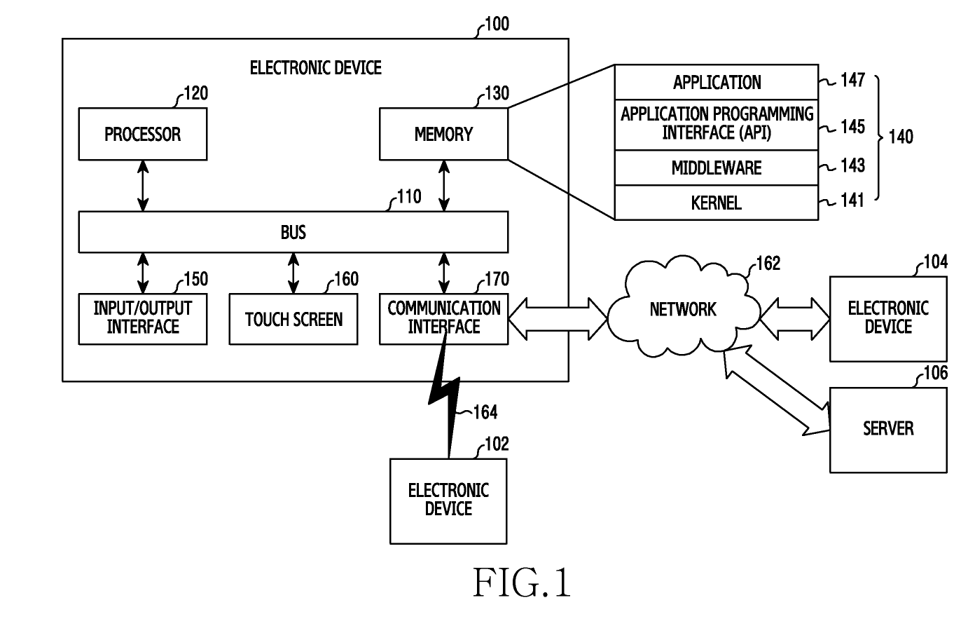

FIG. 1 is a block diagram of an electronic device according to an embodiment of the present disclosure.

Referring to FIG. 1, an electronic device 100 may include a bus 110, a processor 120, a memory 130, an input/output interface 150, a display (e.g., touch screen) 160, and a communication interface 170. According to various embodiments of the present disclosure, at least one of the components of the electronic device 100 may be omitted, or other components may be additionally included in the electronic device 100.

The bus 110 may be a circuit that connects the processor 120, the memory 130, the input/output interface 150, the display 160, or the communication interface 170 and transmits communication (for example, control messages) between the above described components.

The processor 120 may include one or more of a Central Processing Unit (CPU), an Application Processor (AP), and a Communication Processor (CP). For example, the processor 120 may carry out operations or data processing related to control and/or communication of at least one other component of the electronic device 100.

A processor 120 may compare environment information about an environment in which a preset ghost touch can be generated with touch information detected through a touch screen 160, and may thereby detect the ghost touch. For example, the environment information about the environment in which the ghost touch can be generated may include a touch duration time, a touch interval, a touch distance, a touch area, and the like.

According to one embodiment, the processor 120 may detect the ghost touch caused by foreign substances (e.g., water drops) based on the touch duration time of the touch detected through the touch screen 160. For example, when using the capacitive touch screen 160, the processor 120 may determine whether or not a capacitance (that is, a capacitance exceeding a reference capacitance), which has been changed by the touch of the touch screen 160, is continuously maintained until a touch duration time exceeds a reference time. When the changed capacitance of the touch screen 160 is maintained until the touch duration time exceeds the reference time, the processor 120 may determine that the touch of the touch screen 160 is a ghost touch caused by foreign substances.

According to one embodiment, when detecting the ghost touch caused by the foreign substances, the processor 120 may perform a calibration for touch recognition. For example, when using the capacitive touch screen 160, the processor 120 may perform a calibration to prevent the change in the capacitance due to the foreign substances from being recognized as being a touch. For example, the processor 120 may change (e.g., increase) a reference capacitance for touch detection through calibration.

According to one embodiment, when the capacitance is equal to or less than the reference capacitance, which has been changed by the touch of the touch screen 160, and is continuously maintained until the touch duration time exceeds the reference time, the processor 120 may determine that foreign substances (e.g., water drops) are present on the touch screen 160. Accordingly, the processor 120 may perform a calibration for touch recognition.

According to one embodiment, the processor 120 may detect the ghost touch using at least two of a time interval (e.g., a touch detection interval) of touches, a distance between the touches (e.g., a distance between touch points), and touch areas that are detected through the touch screen 160. By way of an example, the ghost touch that is generated by a hardware component may be generated in such a way that a shot group is formed in at least a partial area of the touch screen 160 a dozen times during a specific time (e.g., 1 second). Thus, when the time interval of the touches detected through the touch screen 160 is shorter than a reference time interval (e.g., 0.1 seconds), the processor 120 may set the corresponding touches as a ghost touch candidate group. In order to distinguish a multi-touch from the ghost touch candidate group, the processor 120 may determine that touches, in which a distance between touch points detected through the touch screen 160 is smaller than a reference distance (e.g., 15 Φ), are ghost touches. By way of another example, the processor 120 may update the ghost touch candidate group so that the ghost touch candidate group may include the touches in which the distance between the touch points detected through the touch screen 160 is smaller than the reference distance (e.g., 15 Φ) in order to distinguish the multi-touch from the ghost touch candidate group. When one or more touches, of which a touch area is equal to or less than a reference area (e.g., 4 Φ), are present among the touches included in the ghost touch candidate group, the processor 120 may detect the corresponding touch as being the ghost touch. Here, the touch point may indicate a position in which the touch is detected.

According to one embodiment, when failing to detect the ghost touch based on a time duration of the touch detected through the touch screen 160, the processor 120 may detect the ghost touch using at least two of a time interval of the corresponding touches, a distance of touch points, and a touch area.

According to one embodiment, when the number of times that the ghost touch is detected exceeds the reference number of times of the detection, the processor 120 may perform calibration for touch recognition.

A memory 130 may include a volatile memory and/or a non-volatile memory.

The memory 130 may store commands or data (e.g., a reference pattern or a reference touch area) associated with one or more other components of the electronic device 100. According to one embodiment, the memory 130 may store software and/or a program 140. For example, the program 140 may include a kernel 141, a middleware 143, an API (Application Programming Interface) 145, an application program 147, or the like. At least some of the kernel 141, the middleware 143, and the API 145 may be referred to as an OS (Operating System).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 100 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 100, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 100. Furthermore, the input/output interface 150 may output the instructions or data received from the other element(s) of the electronic device 100 to the user or another external device.

The touch screen 160 may include a display that can display a variety of contents (e.g., text, image, video, icon, symbol, etc.) to a user and a touch panel that can detect a touch. For example, the touch screen 160 may include displays such as an LCD (Liquid Crystal Display), an LED (Light Emitting Diode) display, an OLED (Organic LED) display, an MEMS (microelectromechanical systems) display, an electronic paper display, and the like. For example, the touch screen 160 may include a touch panel capable of receiving a touch, gesture, proximity, or hovering input using a part of an electronic pen or a user's body.

The communication interface 170, for example, may set communication between the electronic device 100 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), or Global System for Mobile Communications (GSM), as a cellular communication protocol. In addition, the wireless communication may include, for example, short range communication 164. The short range communication 164 may include at least one of, for example, WiFi, Bluetooth, Near Field Communication (NFC), or Global Positioning System (GPS).

The wired communication may include at least one of, for example, a Universal Serial Bus (USB), a High Definition Multimedia Interface (HDMI), Recommended Standard-232 (RS-232), or a Plain Old Telephone Service (POTS).

The network 162 may include at least one of a communication network such as a computer network (e.g., a LAN or a WAN), the Internet, and a telephone network.

Each of the first and second external electronic devices 102 and 104 may be a device which is the same as or different from the electronic device 100. According to an embodiment, the server 106 may include a group of one or more servers. According to various embodiments, all or a part of operations performed in the electronic device 100 can be performed in the other electronic device or multiple electronic devices (for example, the external electronic device 102 or 104 or the server 106). According to an embodiment, when the electronic device 100 should perform some functions or services automatically or by a request, the electronic device 100 may make a request for performing at least some functions related to the functions or services to another device (for example, the external electronic device 102 or 104, or the server 106) instead of performing the functions or services by itself or additionally. Another electronic device (e.g., the external electronic device 102 or 104, or the server 106) may perform a function requested from the electronic device 100 or an additional function and transfer the performed result to the electronic device 100. The electronic device 100 can provide the requested function or service to another electronic device by processing the received result as it is or additionally. To this end, for example, cloud computing, distributed computing, or client-server computing technology may be used.

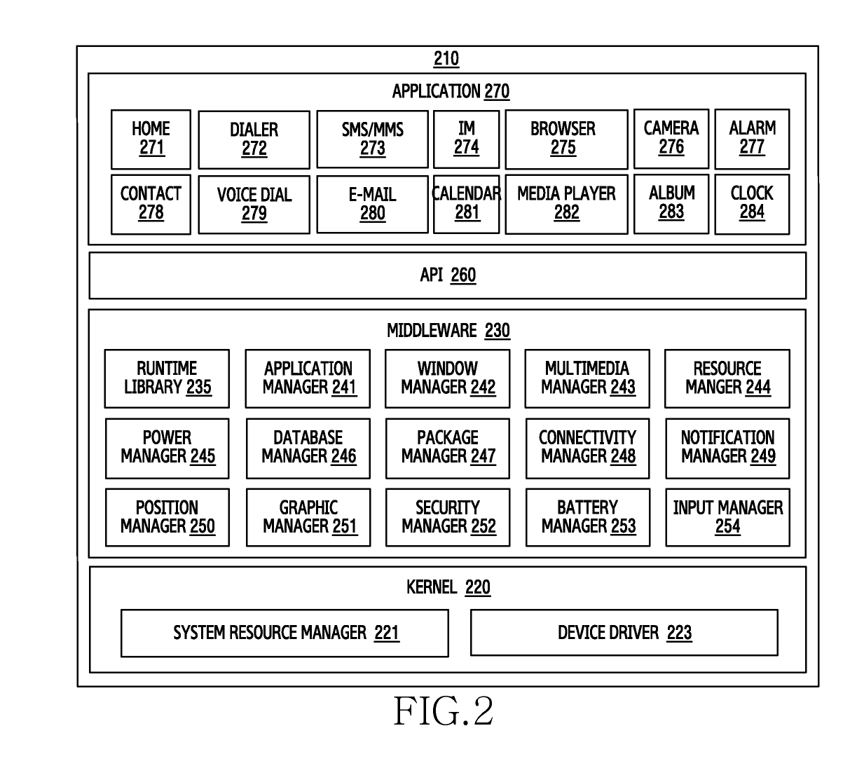

FIG. 2 is a block diagram illustrating a program module according to various embodiments of the present disclosure.

According to one embodiment, a program module 210 (e.g., a program 140) may include an OS for controlling resources associated with an electronic device (e.g., the electronic device 100) and/or various applications (e.g., an application program 147) driven on the OS. The OS may be, for example, Android, iOS, Windows, Symbian, Tizen, Bada, or the like.

The program module 210 may include a kernel 220, a middleware 230, an API 260, and/or an application 270. At least a part of the program module 210 may be preloaded on the electronic device, or downloaded from a server.

The kernel 220 (e.g., the kernel 141 of FIG. 1) may include, for example, a system resource manager 221 or a device driver 223. The system resource manager 221 may perform a control, allocation, recovery, or the like of the system resource. According to an embodiment, the system resource manager 221 may include a process management unit, a memory management unit, a file system management unit, or the like. The device driver 223 may include, for example, a display driver, a camera driver, a Bluetooth driver, a shared memory driver, a USB driver, a keypad driver, a Wi-Fi driver, an audio driver, a battery driver, a touch driver, or an IPC (Inter-Process Communication) driver.

According to one embodiment, the device driver 223 may detect a ghost touch based on the touch information (e.g., a touch duration time, a touch interval, a touch distance, a touch area, etc.) detected through the touch screen 160. For example, the device driver 223 may detect the ghost touch using a touch driver. The device driver 223 may control to prevent touch information corresponding to the ghost touch determined through the touch driver from being transmitted to the middleware 230.

According to one embodiment, the device driver 223 may selectively perform ghost touch detection using the touch driver based on the residual capacity of a battery determined through a battery driver.

The middleware 230 may provide, for example, functions which the application 270 needs in common, or provide various functions to the application 270 through the API 260 so that the application 270 may efficiently use limited system resources in the electronic device. According to an embodiment, the middleware 230 (e.g., the middleware 143) may include at least one of a runtime library 235, an application manager 241, a window manager 242, a multimedia manager 243, a resource manager 244, a power manager 245, a database manager 246, a package manager 247, a connectivity manager 248, a notification manager 249, a location (e.g., position) manager 250, a graphic manager 251, a security manager 252, a battery manager 253, or an input manager 254.

The runtime library 235 may include, for example, a library module used by a compiler in order to add a new function through a programming language while the application 270 is executed. The runtime library 235 may perform a function for input and output management, memory management, or an arithmetic function.

The application manager 241 may manage, for example, a life cycle of at least one of the applications 270. The window manager 242 may manage GUI resources used on a screen. The multimedia manager 243 may ascertain a format utilized for reproducing various media files, and encode or decode a media file using a codec suitable for the corresponding format. The resource manager 244 may manage source codes of at least one of the applications 270, and resources of a memory or a storage space.

The power manager 245 may act with, for example, a BIOS (Basic Input/Output System), or the like in order to manage a battery or a power source, and provide power information utilized for the operation of the electronic device. The database manager 246 may generate, search, or change a database to be used in at least one of the applications 270. The package manager 247 may manage the installation or update of an application distributed by a type of a package file.

The connection manager 248 may manage wireless connection of, for example, Wi-Fi or Bluetooth. The notification manager 249 may display or notify events such as an arrived message, an appointment, and proximity notification in a manner that does not interfere with the user. The location manager 250 may manage location information of the electronic device. The graphic manager 251 may manage a graphic effect to be provided to the user or a UI related to the graphic effect. The security manager 252 may provide all security functions utilized for system security or user authentication. The battery manager 253 may provide the residual quantity information of the battery. The input manager 254 may provide various functions through the API 260 based on input information provided from the I/O interface 150 or the touch screen 160. According to one embodiment, when an electronic device (e.g., the electronic device 100) includes a phone function, the middleware 230 may further include a telephony manager for managing a voice or video call function of the electronic device.

The middleware 230 may include a middleware module that forms a combination of various functions of the above-described components. The middleware 230 may provide a module that is specialized for each kind of an OS to provide a differentiated function. In addition, the middleware 230 may dynamically delete some of the existing components or add new components.

The API 260 (e.g., the API 145) as a set of API programming functions may be provided as different components according to OSs. For example, in case of Android or iOS, one API set may be provided for each platform, and in case of Tizen, two or more API sets may be provided for each platform.

The application 270 (e.g., the application program 147) may include, for example, one or more applications which provide functions such as a home 271, a dialer 272, an SMS/MMS 273, an IM (Instant Message) 274, a browser 275, a camera 276, an alarm 277, a contact 278, a voice dial 279, an e-mail 280, a calendar 281, a media player 282, an album 283, a clock 284, a health care (e.g., measure a momentum or a blood sugar), environment information provision (e.g., provide an atmospheric pressure, humidity, temperature information, or the like), and the like.

According to one embodiment, the application 270 may include an application (hereinafter, for the convenience of description, referred to as “information exchange application”) that supports information exchange between the electronic device (e.g., the electronic device 100) and an external electronic device. The information exchange application may include, for example, a notification relay application for relaying specific information to the external electronic device or a device management application for managing the external electronic device.

For example, the notification relay application may include a function for relaying, to the external electronic device, notification information generated from the other applications (e.g., the SMS/MMS application, the e-mail application, the health care application, or the environment information application) of the electronic device. In addition, the notification relay application may receive, for example, notification information from the external electronic device, and provide the received notification information to the user. The device management application may manage (install, delete, or update), for example, one or more functions (e.g., turn on/turn-off of the external electronic device itself (or some components) or the adjustment of brightness (or resolution) of a display) of the external electronic device communicating with the electronic device, applications operated in the external electronic device, or services (e.g., call service or message service) provided from the external electronic device.

According to one embodiment, the application 270 may include an application (e.g., health care application) designated according to attributes (e.g., the type of the electronic device is a mobile medical device, as the attribute of the electronic device) of the external electronic device. According to one embodiment, the application 270 may include an application received from the external electronic device (e.g., a server or an electronic device). According to one embodiment, the application 270 may include a preloaded application or a third party application capable of being downloaded from a server. Names of the components of the program module 210 according to the shown embodiment may be changed according to the types of the OSs.

According to various embodiments, one or more parts of the program module 210 may be implemented by software, firmware, hardware, or a combination of at least two thereof. The one or more parts of the program module 210 may be implemented (e.g., executed) by, for example, a processor (e.g., an application program of an application). The one or more parts of the program module 210 may include, for example, a module, a program, a routine, a set of instructions, a process, or the like for performing one or more functions.

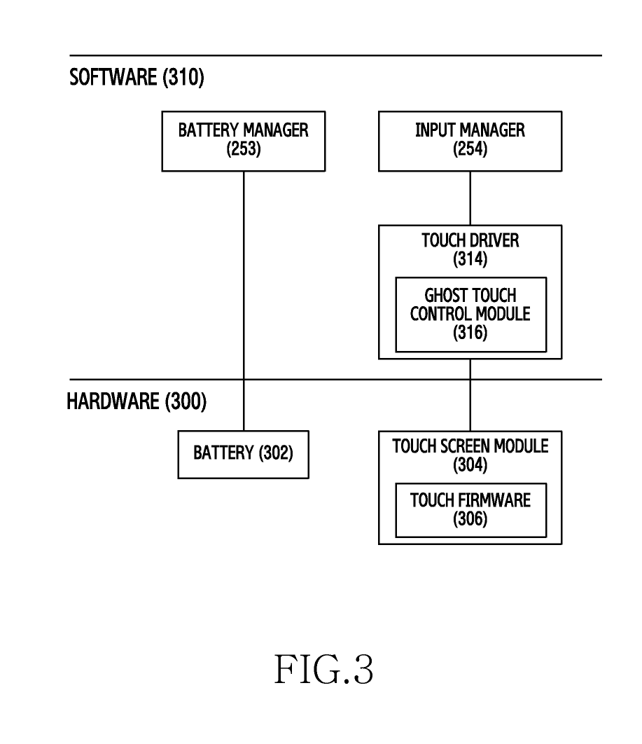

FIG. 3 is a block diagram illustrating a program module for selectively driving a ghost touch detection algorithm according to various embodiments of the present disclosure.

Referring to FIG. 3, the battery manager 253, which is a software component 310 of the electronic device 100, may determine the residual quantity information of a battery 302, which is a hardware component 300 of the electronic device 100. For example, the battery manager 253 of the middleware 230 may determine the residual quantity information of the battery 302 through a battery driver of the kernel 220.

According to one embodiment, when detecting a change in the residual quantity of the battery 302, the battery manager 253 may transmit information about the change in the residual quantity of the battery to one or more other software components 310 (e.g., another manger included in the middleware 230 or the touch driver 314).

The touch driver 314 may detect a ghost touch among touches provided from a touch screen module (e.g., TSP (Touch Screen Panel)) 304 through a ghost touch control module 316.

According to one embodiment, the touch driver 314 may selectively drive the ghost touch control module 316 based on the residual quantity information of the battery 302. For example, the touch driver 314 may receive the residual quantity information of the battery from at least one of the battery driver of the kernel 220 or the battery manager 253 of the middleware 230. When a residual quantity of a battery is smaller than a reference residual quantity, the touch driver 314 may deactivate the ghost touch control module 316 and may thereby provide, to the input manager 254, the input information (e.g., touch information) provided from the touch screen module 304. When the residual quantity of the battery is larger than the reference residual quantity, the touch driver 314 may determine whether a touch provided from the touch screen module 304 by activating the ghost touch control module 316 is a ghost touch. The touch driver 314 may control to prevent the touch detected as being the ghost touch through the ghost touch control module 316 from being provided to the input manager 254. Here, the reference residual quantity may include reference residual quantity information of the battery stored in advance in the memory 130 in order to determine whether the ghost touch control module 316 is being driven.

In cases of FIGS. 1 to 3, the electronic device 100 may detect the ghost touch through the kernel 141 or 220.

According to one embodiment, the electronic device 100 may detect the ghost touch using one or more managers included in the middleware 143 or 230 or an application program included in the application 147 or 270.

According to one embodiment, the electronic device 100 may detect the ghost touch using a touch firmware 306 of the touch screen module 304 which is the hardware component 300. For example, when detecting the ghost touch using the touch firmware 306, the software component 310 (e.g., the battery driver of the kernel 220 or the battery manager 253 of the middleware 230) of the electronic device 100 may transmit a control command for selective driving of ghost touch detection to the touch screen module 304.

According to various embodiments, an electronic device may include a touch screen and a processor that detects a ghost touch based on at least two of a time interval between touches, a distance between touches, and a touch area, with respect to touches detected through the touch screen.

According to various embodiments, the processor may detect touches in which a detection time interval between touches is shorter than a reference time interval or a distance between touches is smaller than a reference distance among the touches detected through the touch screen, and determine one or more touches in which the touch area is smaller than a reference area among the detected touches, as being the ghost touch.

According to various embodiments, the processor may perform calibration with respect to the touch screen based on ghost touch detection or the number of times that the ghost touch is detected.

According to various embodiments, the processor may selectively determine ghost touch detection with respect to the touches detected through the touch screen, based on operating state information of the electronic device.

According to various embodiments, an operating state of the electronic device may include at least one of a residual quantity of a battery, an internal temperature of the electronic device, an external temperature of the electronic device, or a characteristic of a driven application program.

According to various embodiments, the electronic device may further include a memory that includes one or more program modules of a kernel, a middleware, an API, and an application program, and the processor may determine whether the touches detected through the touch screen are the ghost touches using the kernel or the middleware.

According to various embodiments, the processor may determine the distance between the touches using a distance between center coordinates of the touches.

According to various embodiments, the processor may detect the ghost touch based on a touch duration time of the touch detected through the touch screen.

According to various embodiments, the processor may detect the ghost touch based on a touch duration time of a touch corresponding to a change in a capacitance exceeding a reference capacitance.

According to various embodiments, the processor may perform calibration with respect to the touch screen, when detecting the ghost touch based on the touch duration time.

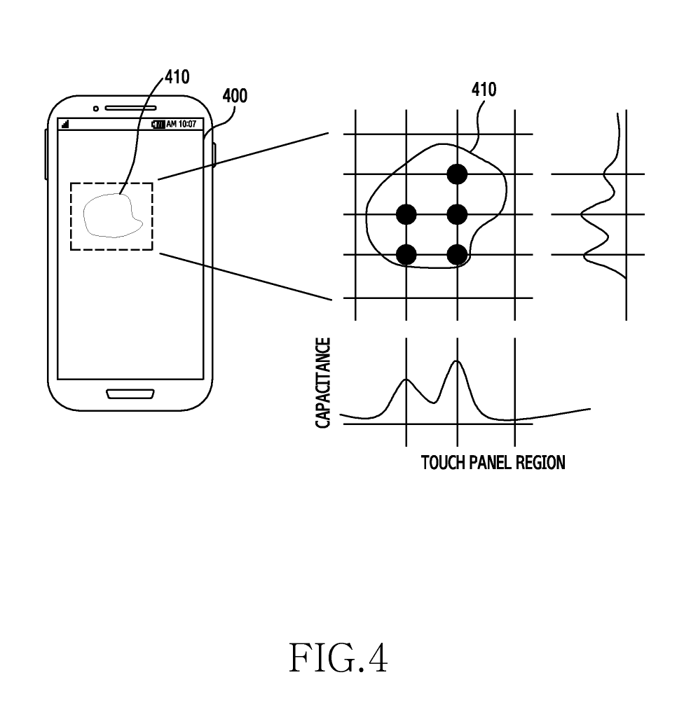

FIG. 4 illustrates a configuration of detecting a ghost touch caused by foreign substances according to various embodiments of the present disclosure.

Referring to FIG. 4, when foreign substances (e.g., water drops) 410 are stained on a touch screen 400 (e.g., the touch screen 160 of FIG. 1) of an electronic device (e.g., the electronic device 100 of FIG. 1), the electronic device may detect a touch due to a change in a capacitance caused by the foreign substances.

When the foreign substances 410 are continuously stained on the touch screen 400, the electronic device may continuously detect a touch corresponding to the capacitance (a capacitance exceeding a reference capacitance) changed by the foreign substances. Accordingly, when the change in the capacitance by the touch is continued for a reference time, the electronic device may determine that the corresponding touch is a ghost touch caused by the foreign substances.

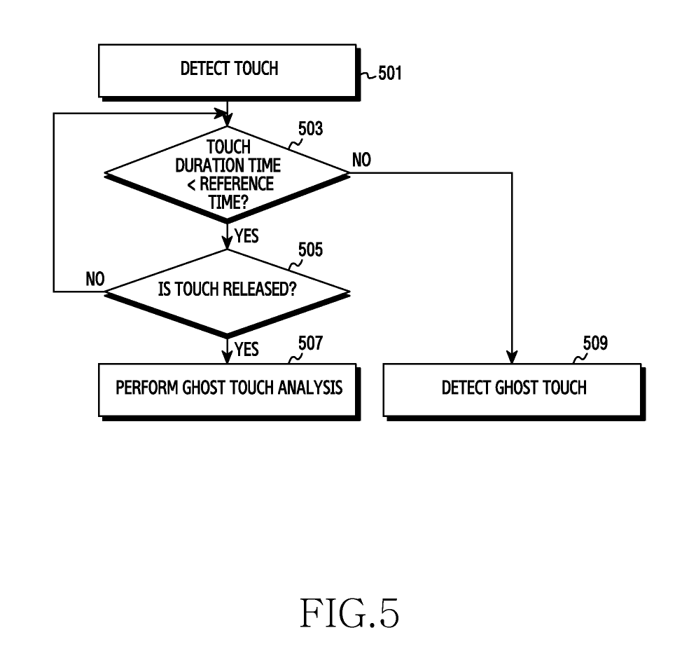

FIG. 5 illustrates a flowchart for detecting a ghost touch based on a touch duration time in an electronic device according to various embodiments of the present disclosure.

Referring to FIG. 5, in operation 501, an electronic device (e.g., the electronic device 100 of FIG. 1) may detect a touch. For example, when using a capacitive touch scheme, the electronic device may detect the touch based on a change in a capacitance exceeding a reference capacitance.

In operation 503, the electronic device may determine whether a touch duration time is shorter than a reference time. For example, the touch duration time may include a time during which the change in the capacitance by the corresponding touch is continued from a point of time when the touch is detected in operation 501.

In operation 505, the electronic device may determine whether the touch is released when the touch duration time is shorter than the reference time. For example, the electronic device may determine whether the change in the capacitance is changed into a zero level after the touch is released. For example, when the capacitance is changed into a reference capacitance or less, the electronic device may determine that the touch has been released.

In operation 507, when the touch is released, the electronic device may additionally analyze whether the corresponding touch is a ghost touch based on touch information detected in operation 501. For example, the touch information may include at least one of a touch duration time, a touch interval, a touch distance, or a touch area.

In operation 503, when the touch is not released, the electronic device may determine again whether the touch duration time is shorter than the reference time.

In operation 509, when the touch duration time is equal to or longer than the reference time, the electronic device may determine the corresponding touch is the ghost touch.

According to one embodiment, when detecting the ghost touch caused by foreign substances based on the touch duration time, the electronic device may perform calibration for touch recognition.

According to one embodiment, when the change in the capacitance equal to or less than the reference capacitance, which is incapable of detecting the touch is continued for the reference time, the electronic device may determine that the capacitance of the touch screen 160 is changed by the foreign substances. Accordingly, the electronic device may perform calibration for touch recognition.

According to various embodiments, when the touch duration time with respect to a point in which the touch is detected is continued for the reference time or longer, the electronic device (e.g., the electronic device 100 of FIG. 1) may determine that the corresponding touch is the ghost touch. For example, when the touch duration time with respect to a specific touch point is maintained for the reference time or longer, the electronic device may determine that the corresponding touch is the ghost touch.

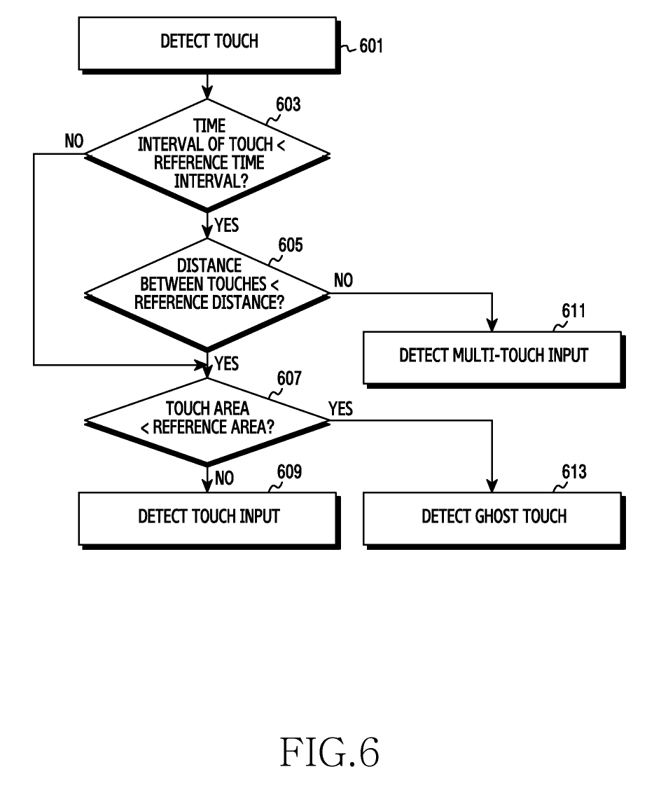

FIG. 6 illustrates a flowchart for detecting a ghost touch based on a touch interval, a touch distance, and a touch area in an electronic device according to various embodiments of the present disclosure.

Referring to FIG. 6, in operation 601, an electronic device (e.g., the electronic device 100 of FIG. 1) may detect a touch.

In operation 603, the electronic device may determine whether a time interval (a touch event detection interval) between touches detected through a touch screen (e.g., the touch screen 160 of FIG. 1) is shorter than a reference time interval (e.g., 0.1 seconds).

In operation 607, when the time interval between the touches is equal to or longer than the reference time interval, the electronic device may determine whether an area of each of the corresponding touches is smaller than a reference area (e.g., 4 Φ). For example, the electronic device may compare an area of each of touches of which the touch event detection interval is equal to or longer than the reference time interval with the reference area.

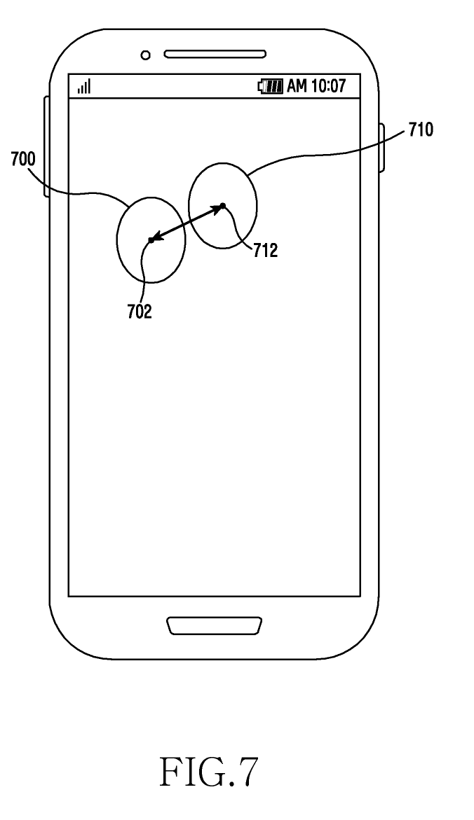

In operation 605, when the time interval between the touches is shorter than the reference time interval, the electronic device may determine whether a distance between the corresponding touches (a distance between touch points) is smaller than a reference distance (e.g., 15 Φ). For example, the electronic device may set touches in which the time interval between the touches is shorter than the reference time interval, among the touches detected through the touch screen, as a ghost touch candidate group. The electronic device may compare a distance between the touches included in the ghost touch candidate group with the reference distance. For example, when a first touch 700 and a second touch 710 of FIG. 7 are included in the ghost touch candidate group, the electronic device may compare a distance between touch coordinates 702 by the first touch 700 and touch coordinates 712 by the second touch 710 with the reference distance. For example, the touch coordinates 702 by the first touch 700 and the touch coordinates 712 by the second touch 710 may include center coordinates determined by a touch firmware algorithm.

In operation 611, when the distance between the touches is equal to or larger than the reference distance, the electronic device may determine that the corresponding touches are multi-touches, and detect a multi-touch input corresponding to the corresponding touches.

In operation 607, when the distance between the touches is smaller than the reference distance, the electronic device may determine whether an area of each of the corresponding touches is smaller than a reference area (e.g., 4 Φ). For example, the electronic device may update the ghost touch candidate group based on the comparison information between the distance between the touches and the reference distance. For example, the electronic device may set, as the ghost touch candidate group, touches in which the time interval between the touches is shorter than the reference time interval and the distance between the touches is smaller than the reference distance among the touches detected through the touch screen. The electronic device may compare an area of each of the touches included in the updated ghost touch candidate group with the reference area.

In operation 609, when the area of each of the touches is equal to or larger than the reference area, the electronic device may detect a touch input corresponding to the corresponding touch. For example, the electronic device may detect a touch input corresponding to the touch of which an area is equal to or larger than the reference area among the touches included in the ghost touch candidate group updated in operation 607.

In operation 613, when the area of each of the touches is smaller than the reference area, the electronic device may determine that the corresponding touch is the ghost touch. For example, the electronic device may determine that the touch in which the touch area is smaller than the reference area among the touches included in the ghost touch candidate group updated based on the distance between the touches is the ghost touch.

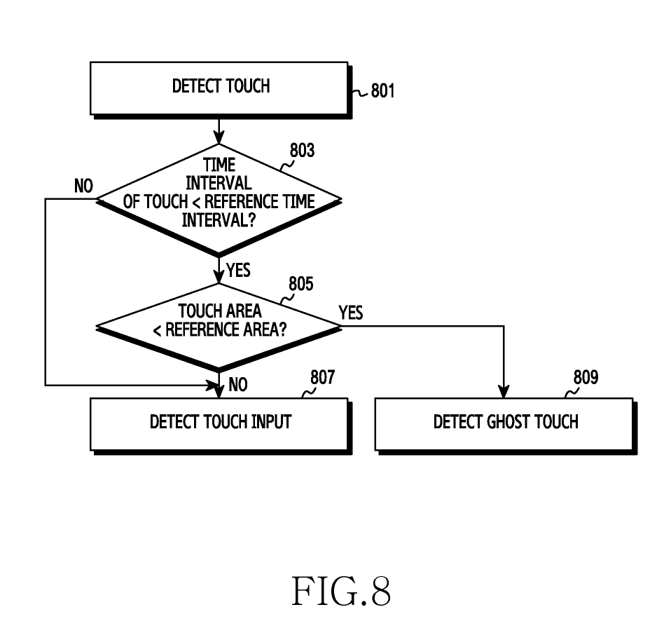

FIG. 8 illustrates a flowchart for detecting a ghost touch based on a touch interval and a touch area in an electronic device according to various embodiments of the present disclosure.

Referring to FIG. 8, in operation 801, an electronic device (e.g., the electronic device 100 of FIG. 1) may detect a touch. For example, when including the capacitive touch screen 160, the electronic device may detect a touch input based on a change in a capacitance (such as a capacitance exceeding a reference capacitance) of the touch screen 160.

In operation 803, the electronic device may determine whether a time interval (e.g., a touch event detection interval) between touches detected through a touch screen (e.g., the touch screen 160 of FIG. 1) is shorter than a reference time interval (e.g., 0.1 seconds).

In operation 807, when the time interval between the touches is equal to or longer than the reference time interval, the electronic device may detect the touch as a touch input. For example, the electronic device may determine that touches for which the touch event detection interval is equal to or longer than the reference time interval are touch inputs.

In operation 805, when the time interval between the touches is shorter than the reference time interval, the electronic device may determine whether an area of each of the corresponding touches is smaller than a reference area (e.g., 4 Φ). For example, the electronic device may set, as a ghost touch candidate group, touches in which a time interval between touches is shorter than the reference time interval (e.g., from among the touches detected through the touch screen 160). The electronic device may compare an area of each of the touches included in the ghost touch candidate group with a reference area.

In operation 807, when the touch area is equal to or larger than the reference area, the electronic device may detect a touch input corresponding to the corresponding touch. For example, the electronic device may detect a touch input corresponding to a touch in which the touch area is equal to or larger than the reference area among the touches included in the ghost touch candidate group.

In operation 809, when the touch area is smaller than the reference area, the electronic device may determine that the corresponding touch is the ghost touch. For example, the electronic device may determine that the touch in which the touch area is smaller than the reference area among the touches included in the ghost touch candidate group is the ghost touch.

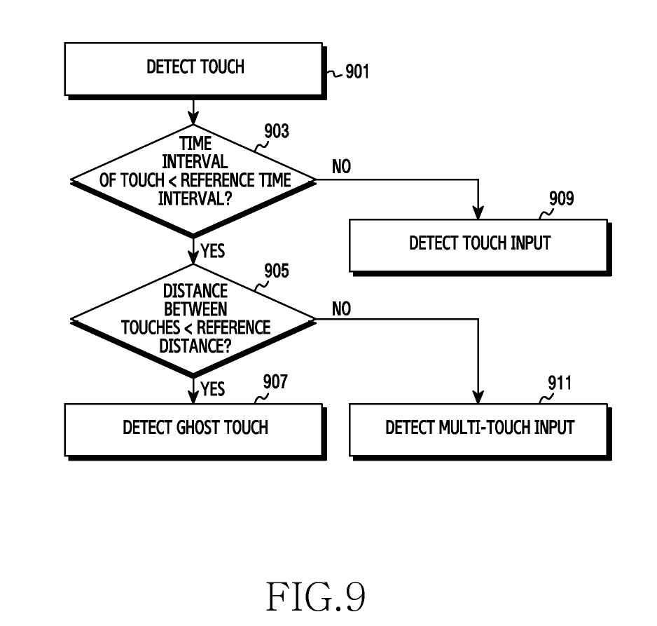

FIG. 9 illustrates a flowchart for detecting a ghost touch based on a touch interval and a touch distance in an electronic device according to various embodiments of the present disclosure.

Referring to FIG. 9, in operation 901, an electronic device (e.g., the electronic device 100 of FIG. 1) may detect a touch. For example, the electronic device may detect a touch input of the touch screen 160 by a touch input means based on a change in a capacitance of the touch screen 160 or changes in resistance and current thereof.

In operation 903, the electronic device may determine whether a time interval (i.e., a touch event detection interval) between touches detected through a touch screen (e.g., the touch screen 160 of FIG. 1) is shorter than a reference time interval (e.g., 0.1 seconds).

In operation 909, when the time interval between the touches is equal to or longer than the reference time interval, the electronic device may detect a touch input corresponding to the corresponding touches. For example, the electronic device may determine that touches of which the touch event detection interval is equal to or longer than the reference time interval are normal touch inputs other than ghost touches.

In operation 905, when the time interval between the touches is shorter than the reference time interval, the electronic device may determine whether a distance between the corresponding touches is smaller than a reference distance (e.g., 15 Φ). For example, the electronic device may set, as a ghost touch candidate group, touches in which a time interval between touches is shorter than a reference time interval among the touches detected through the touch screen. The electronic device may compare a distance between the touches included in the ghost touch candidate group with a reference distance.

In operation 907, when the distance between the touches is smaller than the reference distance, the electronic device may determine that the corresponding touches are ghost touches. For example, the electronic device may determine that touches in which a distance between the touches is smaller than the reference distance among the touches included in the ghost touch candidate group are the ghost touches.

In operation 911, when the distance between the touches is equal to or larger than the reference distance, the electronic device may detect the touches as a multi-touch input.

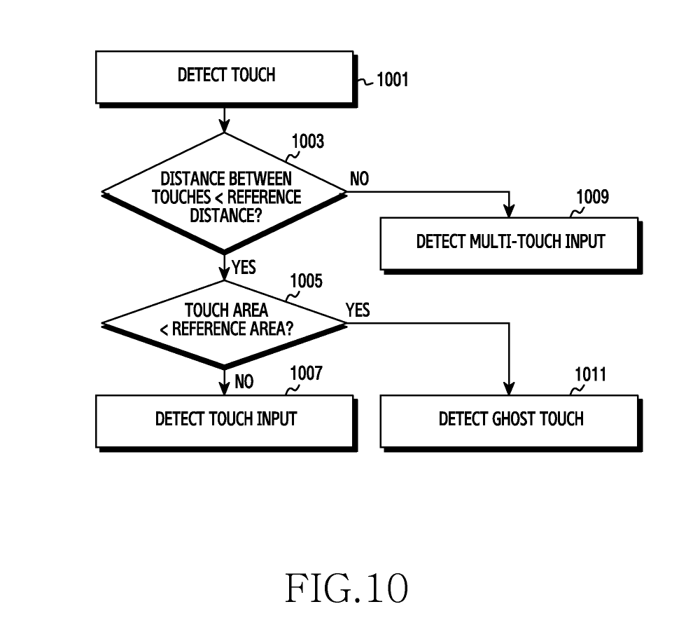

FIG. 10 illustrates a flowchart for detecting a ghost touch based on a touch distance and a touch area in an electronic device according to various embodiments of the present disclosure.

Referring to FIG. 10, in operation 1001, an electronic device (e.g., the electronic device 100 of FIG. 1) may detect a touch. For example, the electronic device may detect a touch input based on a change in a capacitance or changes in resistance and current, which have been detected through the touch screen 160.

In operation 1003, the electronic device may determine whether a distance between touches detected through a touch screen (e.g., the touch screen 160 of FIG. 1) is smaller than a reference distance (e.g., 15 Φ). For example, the electronic device may compare a distance of center coordinates between the touches with the reference distance.

In operation 1009, when the distance between the touches is equal to or larger than the reference distance, the electronic device may detect a multi-touch input corresponding to the corresponding touches. For example, the electronic device may determine that the touches in which the distance between the touches is equal to or larger than the reference distance are normal touch inputs.

In operation 1005, when the distance between the touches is smaller than the reference distance, the electronic device may determine whether an area of each of the corresponding touches is smaller than a reference area (e.g., 4 Φ). For example, the electronic device may set, as a ghost touch candidate group, touches in which the distance between the touches is smaller than the reference distance among the touches detected through the touch screen. The electronic device may compare the area of each of the touches included in the ghost touch candidate group with the reference area.

In operation 1007, when the touch area is equal to or larger than the reference area, the electronic device may detect a touch input corresponding to the corresponding touch. For example, the electronic device may detect a touch input corresponding to the touch in which the touch area is equal to or larger than the reference area among the touches included in the ghost touch candidate group.

In operation 1011, when the touch area is smaller than the reference area, the electronic device may determine that the corresponding touch is the ghost touch. For example, the electronic device may determine that the touch in which the touch area is smaller than the reference area among the touches included in the ghost touch candidate group is the ghost touch.

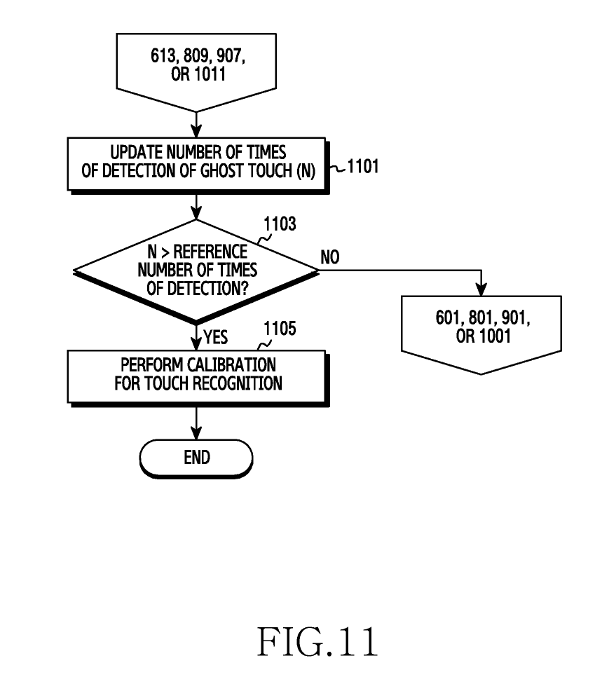

FIG. 11 illustrates a flowchart for performing calibration for touch recognition in an electronic device according to various embodiments of the present disclosure.

Referring to FIG. 11, in operation 1011, when detecting a ghost touch (e.g., operation 613 of FIG. 6, operation 809 of FIG. 8, operation 907 of FIG. 9, or operation 1011 of FIG. 10), an electronic device (e.g., the electronic device 100 of FIG. 1) may update a count of the number of times that the ghost touch is detected (e.g., incrementing a count via “N++”).

In operation 1103, the electronic device may determine whether the count of the number of times that the ghost touch is detected exceeds the threshold limit or reference number.

In operation 1105, when the count of the number of times that the ghost touch is detected exceeds the reference number, the electronic device may perform a calibration for touch recognition. For example, when performing a calibration for touch recognition, the electronic device may initialize the number of times that the ghost touch is detected.

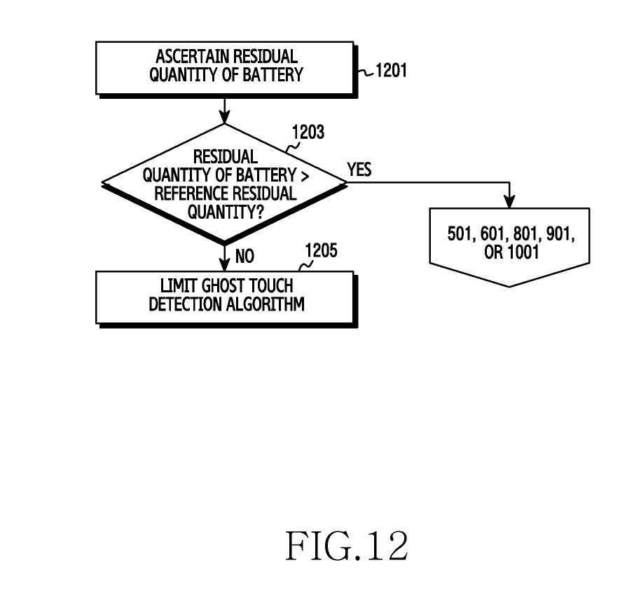

The electronic device may again determine whether a touch is detected when the number of times that the ghost touch is detected is equal to or smaller than the reference number of times of the detection (e.g., proceeding thus to operation 601 of FIG. 6, operation 801 of FIG. 8, operation 901 of FIG. 9, or operation 1001 of FIG. 10). FIG. 12 illustrates a flowchart for selectively performing a ghost touch detection algorithm in an electronic device according to various embodiments of the present disclosure.

Referring to FIG. 12, in operation 1201, an electronic device (e.g., the electronic device 100 of FIG. 1) may ascertain the residual quantity of the battery (e.g., remaining charge). For example, the electronic device 100 may ascertain the residual quantity information of the battery 302 (i.e., a hardware component 300 from FIG. 3 of the electronic device 100) through a battery driver 312 of the kernel 220.

In operation 1203, the electronic device may ascertain whether the residual quantity of the battery is larger than a reference residual quantity.

In operation 1205, when the residual quantity of the battery is equal to or smaller than the reference residual quantity, the electronic device may limit the operation of a ghost touch detection algorithm. For example, when the residual quantity of the battery is equal to or smaller than the reference residual quantity, the electronic device may deactivate the ghost touch control module 316 included in the touch driver 314, and may thereby provide information provided from the touch screen module 304 to the input manager 254 of the middleware 230.

When the residual quantity of the battery is larger than the reference residual quantity, the electronic device may drive the ghost touch detection algorithm (e.g., thus proceeding to 501 of FIG. 5, 601 of FIG. 6, 801 of FIG. 8, 901 of FIG. 9, or 1001 of FIG. 10).

According to one embodiment, when detecting the touch, the electronic device may ascertain the residual quantity of the battery of the electronic device in operation 1201, and compare the residual quantity of the battery with the reference residual quantity in operation 1203. The electronic device may selectively drive the ghost touch detection algorithm based on the comparison result between the residual quantity of the battery and the reference residual quantity.

According to various embodiments of the present disclosure, an electronic device may selectively drive a ghost touch detection algorithm based on operating state information of the electronic device such as a residual quantity of a battery, a temperature (an internal temperature or an external temperature) of the electronic device or a characteristic (e.g., type) of a driven (e.g., executing) application program.

According to various embodiments of the present disclosure, a method for operating an electronic device may include detecting touches detected through a touch screen, and detecting a ghost touch based on at least two of a time interval between the touches detected through the touch screen, a distance between the touches, and a touch area.

According to various embodiments, the detecting of the ghost touch may include detecting touches in which a detection time interval between touches is shorter than a reference time interval or a distance between touches is smaller than a reference distance among the touches detected through the touch screen, and determining one or more touches in which the touch area is smaller than a reference area among the detected touches as being the ghost touch.

According to various embodiments, the method may further include performing calibration with respect to the touch screen based on the ghost touch detection or the number of times that the ghost touch is detected.

According to various embodiments, the method may further include determining whether to detect the ghost touch with respect to the touches detected through the touch screen based on operating state information of the electronic device, and, when it is determined to detect the ghost touch, the method may proceed to the detecting of the ghost touch based on the at least two of the time interval between the touches detected through the touch screen, the distance between the touches, and the touch area.

According to various embodiments, the operating state information of the electronic device may include at least one of a residual quantity of a battery, an internal temperature of the electronic device, an external temperature of the electronic device, or a characteristic of a driven application program.

According to various embodiments, the detecting of the ghost touch may include determining whether the touches detected through the touch screen are the ghost touches using a kernel or a middleware included in a memory of the electronic device.

According to various embodiments, the distance between the touches may include a distance between center coordinates of the touches.

According to various embodiments, the method may further include detecting the ghost touch based on a touch duration time of the touch detected through the touch screen.

According to various embodiments, the detecting of the ghost touch based on the touch duration time may include detecting the ghost touch based on a touch duration time of a touch corresponding to a change in a capacitance exceeding a reference capacitance.

According to various embodiments, the method may further include performing calibration with respect to the touch screen, when detecting the ghost touch based on the touch duration time of the touch.

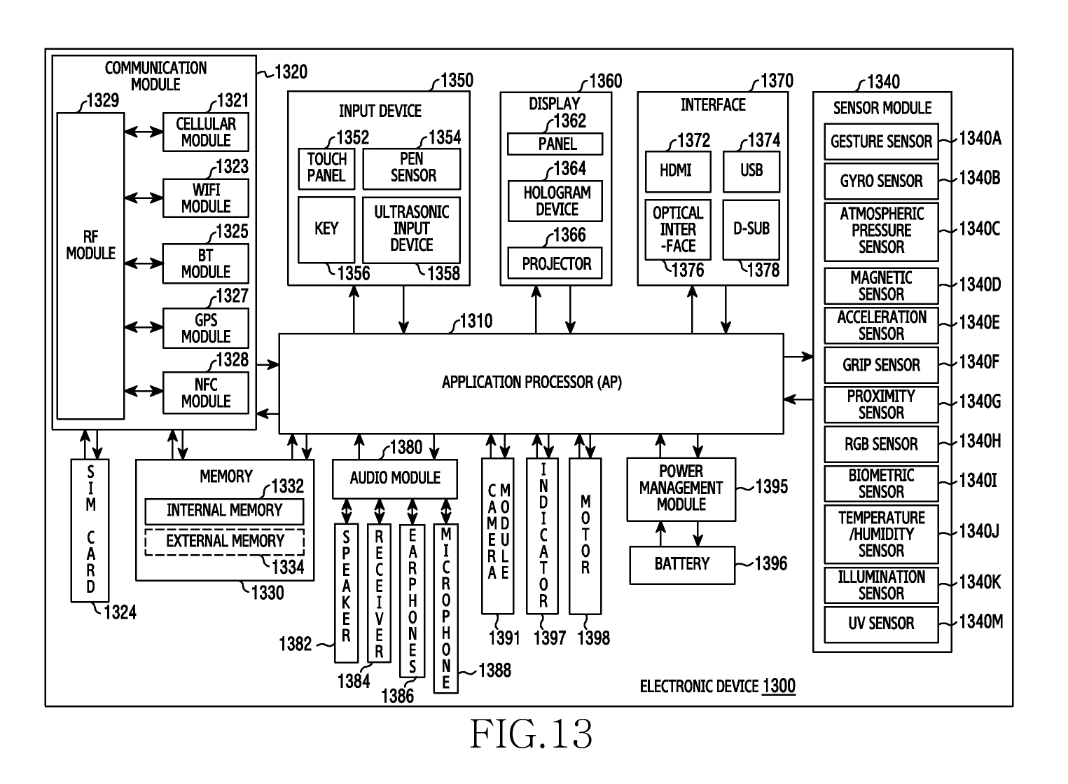

FIG. 13 illustrates a block diagram of an electronic device according to an example embodiment of the present disclosure. In the following description, the electronic device 1300 may, for example, implement the whole or part of the electronic device 100 illustrated in FIG. 1.

Referring to FIG. 13, the electronic device 1300 may include one or more Application Processors (APs) 1310, a communication module 1320, a Subscriber Identification Module (SIM) card 1324, a memory 1330, a sensor module 1340, an input device 1350, a display 1360, an interface 1370, an audio module 1380, an image sensor module 1391, a power management module 1395, a battery 1396, an indicator 1397, or a motor 1398.

The AP 1310 may run an operating system or an application program to control a plurality of hardware or software constituent elements connected to the AP 1310, and may perform processing and operation of various data including multimedia data. The AP 1310 may be, for example, implemented as a System On Chip (SoC). According to one example embodiment, the AP 1310 may further include a Graphic Processing Unit (GPU) (not shown).

The communication module 1320 (e.g., the communication interface 170) may perform data transmission/reception in communication between the electronic device 1300 (e.g., the electronic device 101) and other electronic devices connected through a network. According to one example embodiment, the communication module 1320 may include a cellular module 1321, a WiFi module 1323, a BT module 1325, a GPS module 1327, an NFC module 1328, and a Radio Frequency (RF) module 1329.

The cellular module 1321 may provide voice telephony, video telephony, a text service, or an Internet service, etc. through a telecommunication network (e.g., LTE, LTE-A, CDMA, WCDMA, UMTS, WiBro, or GSM, etc.). Also, the cellular module 1321 may, for example, use a subscriber identification module (e.g., the SIM card 1324) to perform electronic device distinction and authorization within the telecommunication network. According to one example embodiment, the cellular module 1321 may perform at least some of functions that the AP 1310 may provide. For example, the cellular module 1321 may perform at least one part of a multimedia control function.

According to one example embodiment, the cellular module 1321 may include a Communication Processor (CP). Also, the cellular module 1321 may be, for example, implemented as a SoC. In FIG. 13, the constituent elements such as the cellular module 1321 (e.g., the communication processor), the memory 1330, or the power management module 1395, etc. are illustrated as constituent elements different from the AP 1310 but, according to one example embodiment, the AP 1310 may be implemented to include at least some (e.g., the cellular module 1321) of the aforementioned constituent elements.

According to one example embodiment, the AP 1310 or the cellular module 1321 (e.g., the communication processor) may load an instruction or data, which is received from a non-volatile memory connected to each or at least one of other constituent elements, to a volatile memory and process the loaded instruction or data. Also, the AP 1310 or the cellular module 1321 may store in the non-volatile memory data, which is received from at least one of the other constituent elements or is generated by at least one of the other constituent elements.

The WiFi module 1323, the BT module 1325, the GPS module 1327 or the NFC module 1328 each may include, for example, a processor for processing data transmitted/received through the corresponding module. In FIG. 13, the cellular module 1321, the WiFi module 1323, the BT module 1325, the GPS module 1327 or the NFC module 1328 is each illustrated as a separate block but, according to one example embodiment, at least some (e.g., two or more) of the cellular module 1321, the WiFi module 1323, the BT module 1325, the GPS module 1327 or the NFC module 1328 may be included within one IC or IC package. For example, at least some (e.g., a communication processor corresponding to the cellular module 1321 and a WiFi processor corresponding to the WiFi module 1323) of the processors corresponding to the cellular module 1321, the WiFi module 1323, the BT module 1325, the GPS module 1327 or the NFC module 1328 may be implemented as one SoC.

The RF module 1329 may perform transmission/reception of data, for example, transmission/reception of an RF signal. Though not illustrated, the RF module 1329 may include, for example, a transceiver, a Power Amplifier Module (PAM), a frequency filter, or a Low Noise Amplifier (LNA), etc. Also, the RF module 1329 may further include a component for transmitting/receiving an electromagnetic wave on a free space in wireless communication, for example, a conductor or a conductive wire, etc. FIG. 13 illustrates that the cellular module 1321, the WiFi module 1323, the BT module 1325, the GPS module 1327 and the NFC module 1328 share one RF module 1329 with one another but, according to one example embodiment, at least one of the cellular module 1321, the WiFi module 1323, the BT module 1325, the GPS module 1327 or the NFC module 1328 may perform transmission/reception of an RF signal through a separate RF module.

According to one example embodiment, the RF module 1329 may include at least one antenna among a main antenna and a sub antenna which are operatively connected with the electronic device 1300. The communication module 1320 may use the main antenna and the sub antenna to support a Multiple Input Multiple Output (MIMO) such as diversity, etc.

The SIM card 1324 may be a card including a subscriber identification module, and may be inserted into a slot provided in a specific position of the electronic device 1300. The SIM card 1324 may include unique identification information (e.g., an Integrated Circuit Card ID (ICCID)) or subscriber information (e.g., an International Mobile Subscriber Identity (IMSI)).

The memory 1330 may include an internal memory 1332 or an external memory 1334. The internal memory 1332 may include, for example, at least one of a volatile memory (for example, a Dynamic Random Access Memory (DRAM), a Static RAM (SRAM) and a Synchronous Dynamic RAM (SDRAM)) or a non-volatile memory (for example, a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, or a Not OR (NOR) flash memory).

According to one example embodiment, the internal memory 1332 may be a Solid State Drive (SSD). The external memory 1334 may further include a flash drive, for example, Compact Flash (CF), Secure Digital (SD), micro-SD, mini-SD, extreme Digital (xD), or a memory stick, etc. The external memory 1334 may be operatively connected with the electronic device 1300 through various interfaces. According to one example embodiment, the electronic device 1300 may further include a storage device (or a storage media) such as a hard drive.

The sensor module 1340 may measure a physical quantity or sense an activation state of the electronic device 1300, and convert measured or sensed information into an electric signal. The sensor module 1340 may include, for example, at least one of a gesture sensor 1340A, a gyro sensor 1340B, an air (e.g., atmospheric) pressure sensor 1340C, a magnetic sensor 1340D, an acceleration sensor 1340E, a grip sensor 1340F, a proximity sensor 1340G, a color sensor 1340H (e.g., a Red, Green, Blue or “RGB” sensor), a bio-physical or biometric sensor 1340I, a temperature/humidity sensor 1340J, an illumination sensor 1340K, or a Ultraviolet (UV) sensor 1340M. Additionally or alternatively, the sensor module 1340 may include, for example, an E-nose sensor (not shown), an Electromyography (EMG) sensor (not shown), an Electroencephalogram (EEG) sensor (not shown), an Electrocardiogram (ECG) sensor (not shown), an Infrared (IR) sensor (not shown), an iris sensor (not shown), or a fingerprint sensor (not shown), etc. The sensor module 1340 may further include a control circuit for controlling at least one or more sensors belonging therein.

The input device 1350 may include a touch panel 1352, a (digital) pen sensor 1354, a key 1356, or an ultrasonic input device 1358. The touch panel 1352 may, for example, detect a touch input in at least one of a capacitive overlay scheme, a pressure sensitive scheme, an infrared beam scheme, or an acoustic wave scheme. Also, the touch panel 1352 may further include a control circuit as well. In a case of the capacitive overlay scheme, physical contact or proximity detection is possible. The touch panel 1352 may further include a tactile layer as well. In this case, the touch panel 1352 may provide a tactile response to a user.

The (digital) pen sensor 1354 may be implemented in the same or similar method to receiving a user's touch input or by using a separate sheet for detection. The key 1356 may include, for example, a physical button, an optical key, or a keypad. The ultrasonic input device 1358 is a device capable of identifying data by sensing a sound wave in the electronic device 1300 through an input tool generating an ultrasonic signal, and enables wireless detection. According to one example embodiment, the electronic device 1300 may also use the communication module 1320 to receive a user input from an external device (e.g., a computer or a server) connected with this.

The display 1360 (e.g., the display 160) may include a panel 1362, a hologram device 1364, or a projector 1366. The panel 1362 may be, for example, a Liquid Crystal Display (LCD) or an Active-Matrix Organic Light-Emitting Diode (AMOLED), etc. The panel 1362 may be, for example, implemented to be flexible, transparent, or wearable. The panel 1362 may be implemented as one module along with the touch panel 1352 as well. The hologram device 1364 may use interference of light to show a three-dimensional image in the air. The projector 1366 may project light to a screen to display an image. The screen may be, for example, located inside or outside the electronic device 1300. According to one example embodiment, the display 1360 may further include a control circuit for controlling the panel 1362, the hologram device 1364, or the projector 1366.

The interface 1370 may include, for example, a HDMI 1372, a USB 1374, an optical interface 1376, or a D-subminiature (D-sub) 1378. Additionally or alternatively, the interface 1370 may include, for example, a Mobile High-definition Link (MHL) interface, a Secure Digital (SD) card/Multi Media Card (MMC) interface or an Infrared Data Association (IrDA) interface.

The audio module 1380 may convert a voice and an electric signal interactively. The audio module 1380 may, for example, process sound information which is inputted or outputted through a speaker 1382, a receiver 1384, an earphone 1386, or the microphone 1388, etc.

The image sensor or camera module 1391 is a device able to take a still picture and a moving picture. According to one example embodiment, the image sensor module 1391 may include one or more image sensors (e.g., a front sensor or a rear sensor), a lens (not shown), an Image Signal Processor (ISP) (not shown), or a flash (not shown) (e.g., a Light Emitting Diode (LED) or a xenon lamp).

The power management module 1395 may manage electric power of the electronic device 1300. Though not illustrated, the power management module 1395 may include, for example, a Power Management Integrated Circuit (PMIC), a charger IC, or a battery or fuel gauge.

The PMIC may be, for example, mounted within an integrated circuit or a SoC semiconductor. A charging scheme may be divided into a wired charging scheme and a wireless charging scheme. The charger IC may charge the battery 1396, and may prevent the inflow of overvoltage or overcurrent from an electric charger. According to one example embodiment, the charger IC may include a charger IC for at least one of the wired charging scheme or the wireless charging scheme. The wireless charging scheme may, for example, be a magnetic resonance scheme, a magnetic induction scheme, or an electromagnetic wave scheme, etc. A supplementary circuit for wireless charging, for example, a circuit such as a coil loop, a resonance circuit, or a rectifier may be added.

The battery gauge may, for example, measure a level of the battery 1396, a voltage during charging, a current or a temperature. The battery 1396 may generate or store electricity, and use the stored or generated electricity to supply power to the electronic device 1300. The battery 1396 may include, for example, a rechargeable battery or a solar battery.

The indicator 1397 may display a specific status of the electronic device 1300 or one part (e.g., the AP 1310) thereof, for example a booting state, a message state, or a charging state, etc. The motor 1398 may convert an electric signal into a mechanical vibration. Though not illustrated, the electronic device 1300 may include a processing device (e.g., a GPU) for mobile TV support. The processing device for mobile TV support may, for example, process media data according to the conventions of Digital Multimedia Broadcasting (DMB), Digital Video Broadcasting (DVB), or a media flow.

The electronic device and the method for operating the electronic device according to various embodiments may detect the ghost touch based on environment information (e.g., a touch duration time, a touch interval, a touch distance, a touch area, etc.) in which the occurrence of the ghost touch is possible, thereby reducing the malfunction caused by a user's unintended touch input.

The electronic device and the method for operating the electronic device according to various embodiments may detect the ghost touch by driving an algorithm for detecting the ghost touch in a program module such as a kernel drive, a middleware, or an application, thereby reducing the malfunction caused by the occurrence of the ghost touch in various environments in the markets.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), or a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Further, the embodiments disclosed in this document are only for the description and understanding of technical contents and do not limit the present disclosure. Accordingly, the present disclosure should be construed as including all modifications or various other embodiments based on the technical idea of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The embodiments of the present disclosure disclosed in the specification and the drawings are only particular examples proposed in order to easily describe the technical matters of the present disclosure and help with comprehension of the present disclosure, and do not limit the present disclosure. Therefore, in addition to the embodiments disclosed herein, the various embodiments of the present disclosure should be construed to include all modifications or modified forms drawn based on the technical idea of the various embodiments of the present disclosure.

What is claimed is:

1. An electronic device comprising:
a touch screen configured to detect touches; and
at least one processor configured to process the touches as a touch input or ignore the touches as a ghost touch based on at least two of: a time interval between the touches to the touch screen, a distance between the touches, and a touch area of the touches.

2. The electronic device of claim 1, wherein the processor is further configured to detect one or more touches in which the time interval between touches is shorter than a reference time interval and the touch area is smaller than a reference area among the touches detected through the touch screen, as being the ghost touch, or
detect one or more touches in which the distance between touches is smaller than a reference distance and the touches is smaller than a reference area among the touches detected through the touch screen, as being the ghost touch.

3. The electronic device of claim 1, wherein the processor is further configured to perform calibration with respect to the touch screen based on ghost touch detection or a number of times the ghost touch is detected.

4. The electronic device of claim 1, wherein the processor is further configured to perform ghost touch detection with respect to the touches detected through the touch screen, based on operating state information of the electronic device.

5. The electronic device of claim 4, wherein the operating state information of the electronic device includes at least one of a residual charge of a battery of the electronic device, an internal temperature of the electronic device, an external temperature of the electronic device, and a characteristic of an executing application program.

6. The electronic device of claim 1, further comprising:
a memory including one or more program modules of a kernel, a middleware, an API (Application Programming Interface), and an application program,
wherein the processor is further configured to detect whether the touches are to be processed as the touch input or the ghost touch using the kernel and/or the middleware.

7. The electronic device of claim 1, wherein the processor is configured to detect the distance between the touches using a distance between center coordinates of each the touches.

8. The electronic device of claim 1, wherein the processor is configured to detect the ghost touch based on a touch duration time of one of the touches detected through the touch screen.

9. The electronic device of claim 8, wherein the processor is configured to detect the ghost touch based on the touch duration time of the one of the touches corresponding to a change in a capacitance exceeding a reference capacitance.

10. The electronic device of claim 8, wherein the processor is further configured to perform calibration altering a reference capacitance indicating detection of a touch to the touch screen, when the ghost touch is detected based on the touch duration time.

11. A method in an electronic device, comprising:
detecting touches via a touch screen of the electronic device; and
detecting a ghost touch based on at least two of: a time interval between the touches detected through the touch screen, a distance between the touches, and a touch area of the touches.

12. The method of claim 11, wherein detecting the ghost touch comprises:
detecting one or more touches in which a detection time interval between touches is shorter than a reference time interval and the touch area is smaller than a reference area among the touches detected through the touch screen, as being the ghost touch.

13. The method of claim 11, wherein detecting the ghost touch comprises:
detecting one or more touches in which a distance between touches is smaller than a reference distance and the touch area is smaller than a reference area among the touches detected through the touch screen, as being the ghost touch.

14. The method of claim 11, further comprising:
performing calibration with respect to the touch screen based on ghost touch detection or a number of times the ghost touch is detected exceeds a reference count.

15. The method of claim 11, further comprising:
performing executing ghost touch detection with respect to the touches detected through the touch screen, based on operating state information of the electronic device.

16. The method of claim 15, wherein the operating state information of the electronic device includes at least one of a residual charge of a battery of the electronic device, an internal temperature of the electronic device, an external temperature of the electronic device, and a characteristic of an executing application program.

17. The method of claim 11, wherein the distance between the touches includes a distance between center coordinates of the touches.

18. The method of claim 11, further comprising:
detecting the ghost touch based on a touch duration time of one of the touches detected through the touch screen.

19. The method of claim 18, wherein the ghost touch is further detected based on the touch duration time of the one of the touches corresponding to a change in a capacitance exceeding a reference capacitance.

20. The method of claim 18, further comprising performing calibration altering a reference capacitance indicating detection of a touch to the touch screen, when the ghost touch is detected based on the touch duration time.
